(19) United States
(12) Patent Application Publication
(10) Pub. No.: US 2011/0271724 A1
(43) Pub. Date: Nov. 10, 2011

(54) LOCK CYLINDER ASSEMBLY

(75) Inventors: Chao-Ming Huang, Kaohsiung City (TW); Chi-Ming Chen, Kaohsiung City (TW)

(73) Assignee: TAIWAN FU HSING INDUSTRIAL CO., LTD., Kaohsiung City (TW)

(21) Appl. No.: 13/188,864

(22) Filed: Jul. 22, 2011

Related U.S. Application Data
(63) Continuation-in-part of application No. 12/149,688, filed on May 6, 2008.

(51) Int. Cl. E05B 27/02

(52) U.S. Cl. 70/493

(57) ABSTRACT

A lock cylinder assembly comprises a cylinder body, a plug, a plurality of pin sets and a position block, wherein the plug comprising a keyhole is rotatable within the cylinder body between a locked position and an unlocked position, the pin sets enable the plug disposed relative to the cylinder body to change state between a non-interference state and an interference state, the position block enables the plug disposed relative to the cylinder body to change state between the non-interference state and the interference state, and at least one of the pin sets and the position block is situated in the interference state to disable the lock cylinder from the locked position without a matched key in the keyhole.

### CROSS REFERENCE TO RELATED APPLICATIONS

This application is a continuation-in-part of U.S. patent application Ser. No. 12/149,688, filed on May 6, 2008, and for which priority is claimed under 35 U.S.C. §120, the entire contents of which are hereby incorporated by reference.

### FIELD OF THE INVENTION

The present invention is generally relating to a lock cylinder, more particularly to a lock cylinder assembly that utilizes position block for obtaining anti-prying and anti-hitting efficiency.

### BACKGROUND OF THE INVENTION

The known lock cylinder mainly comprises a cylinder body, a plug and a pin set, the cylinder body and the plug almost dispose pins, wherein the cylinder body disposes a plurality of upper pins having a same height and the plug disposes a plurality of lower pins having different heights. Because of the arrangement between the upper pins and the lower pins, the plug is position-limited by the upper pins or the lower pins unable to turn in the cylinder body, which may function as position-limitation and anti-turn. However, when burglar attempts to illegally unlock lock cylinder of known lock device, he might insert an unmatched key into a keyhole of the plug and provides an opportune beat on the lock, in which the lower pins in the plug are hit by the bitting of the unmatched key to simultaneously hit the upper pins between the cylinder body and the plug, that makes the upper pins move to the cylinder body, and then the plug is opportunely turned by the unmatched key to unlock easily, so that the known lock cylinder lacks in burglar-proof and security seriously in a locked condition.

### SUMMARY

The primary object of the present invention is to provide a lock cylinder assembly comprising at least a cylinder body, a plug, a plurality of pin sets and a position block, wherein the plug comprising a keyhole is rotatable within the cylinder body between a locked position and an unlocked position, the pin sets enable the plug disposed relative to the cylinder body to change state between a non-interference state and an interference state, the position block enables the plug disposed relative to the cylinder body to change state between the non-interference state and the interference state, and at least one of the pin sets and the position block is in the interference state to disable the lock cylinder from the locked position without a matched key in the keyhole. If an unmatched key is inserted into the keyhole of the plug with opportune beat and turn to unlock in a locked condition, the unmatched key beats and moves the position block to make the plug maintained in the locked position and prevent the plug from rotation. Accordingly, because the unmatched key cannot disengage the position block from the plug, a burglary attempting to turn the plug violently for unlocking with an unmatched key may be effectively prevented. In addition, the present invention also utilizes the position block to strengthen lock cylinder structure and increase unlocking difficulty for an unmatched key and thereby widely enhancing burglar-proof and security of the lock cylinder assembly.

### DESCRIPTION OF THE DRAWINGS

FIG. 1 is a perspective exploded view of a lock cylinder assembly in accordance with the first preferred embodiment of the present invention.

FIG. 2 is a perspective assembly view of the lock cylinder assembly in accordance with the first preferred embodiment of the present invention.

FIG. 3 is an assembly sectional view of the lock cylinder assembly in accordance with the first preferred embodiment of the present invention.

FIGS. 4A-4C are motion views showing a matched key is inserted into the lock cylinder assembly in accordance with the first preferred embodiment of the present invention.

FIG. 5 is a sectional view showing an unmatched key is inserted into the lock cylinder assembly.

FIGS. 6A-6B are motion views showing an unmatched key is inserted into the lock cylinder assembly.

FIG. 7 is an assembly sectional view of a lock cylinder assembly in accordance with the second preferred embodiment of the present invention.

FIGS. 8A-8C are motion views showing a matched key is inserted into the lock cylinder assembly in accordance with the second preferred embodiment of the present invention.

FIG. 9 is a sectional view showing an unmatched key is inserted into the lock cylinder assembly.

FIG. 10 is a motion view showing an unmatched key is inserted into the lock cylinder assembly.

### DETAILED DESCRIPTION OF THE INVENTION

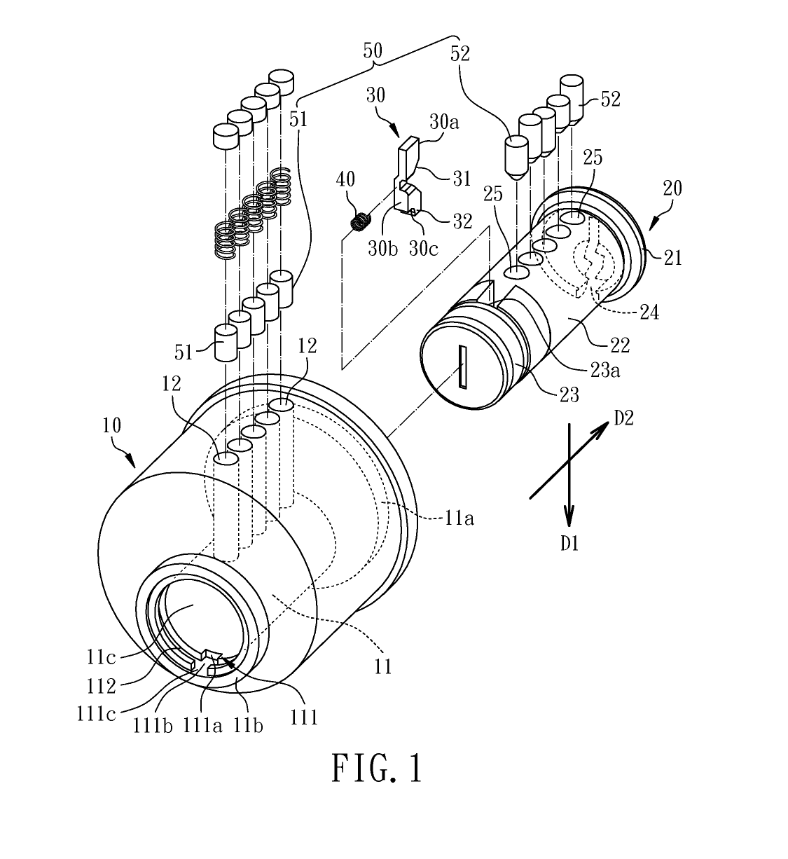

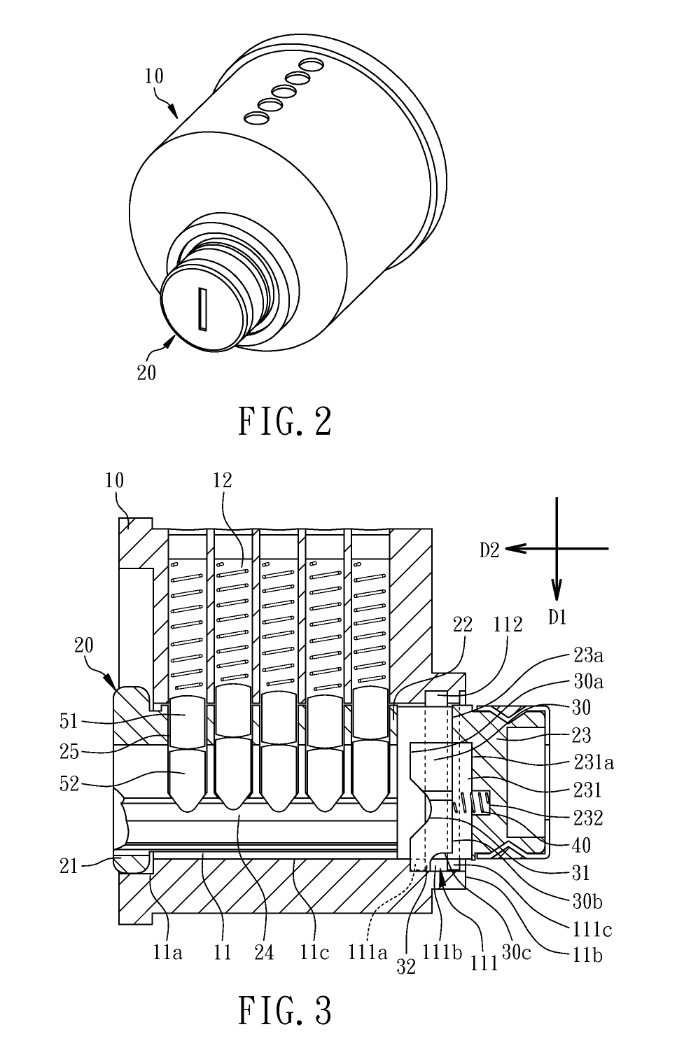

Referring to FIGS. 1, 2 and 3, a lock cylinder assembly in accordance with the first preferred embodiment of the present invention comprises a cylinder body 10, a plug 20, a position block 30, a resilient member 40 and a plurality of pin sets 50. The cylinder body 10 is a hollow cylinder in various appearances having a hollow cylinder portion 11 and a plurality of upper pin holes 12 in communication with the hollow cylinder portion 11. The hollow cylinder portion 11 has a first end 11a, a second end 11b opposite to the first end 11a, an inside wall 11c, an axial groove 111 located at the second end 11b and a radial groove 112 in communication with the axial groove 111, wherein the axial groove 111 and the radial groove 112 recess from the inside wall 11c. In this embodiment, the axial groove 111 comprises a first limiting area 111a, an overlapping area 111b and a second limiting area 111c, wherein the axial groove 111 communicates with and intersects the radial groove 112 at the overlapping area 111b, the first limiting area 111a and the second limiting area 111c are respectively located at two sides of the overlapping area 111b. The overlapping area 111b is an intersection area formed by the radial groove 112 and the axial groove 111. The plug 20 is rotatable and being disposed within the hollow cylinder portion 11 of the cylinder body 10 between a locked position and an unlocked position. Besides, the plug 20 has a front portion 21 corresponding to the first end 11a of the hollow cylinder portion 11, a middle portion 22, a drive portion 23, a keyhole 24 formed at the front portion 21 and the middle portion 22 and a plurality of lower pin holes 25 formed at the middle portion 22. Referring again to FIG. 3, in this embodiment, the drive portion 23 has an inner end face 23a and an accommodating cavity 231 recessed from the inner end face 23a, and the accommodating cavity 231 has a bottom surface 231a. The keyhole 24 communicates with the lower pin holes 25. The lower pin holes 25 correspond and communicate with the upper pin holes 12 of the cylinder body 10 respectively before turning the plug 20. Referring again to FIGS. 1 and 3, the position block 30 is disposed at the keyhole 24 and protruded from the plug 20. In addition, the position block 30 is adjacent to the drive portion 23. The position block 30 enables the plug 20 disposed relative to the cylinder body 10 to change state between the non-interference state and the interference state. In the interference state, the position block 30 is corresponded to the axial groove 111 of the hollow cylinder portion 11 capable of limiting the plug 20 not to be turned around.

In this embodiment, at least one of the pin sets 50 and the position block 30 is in the interference state to disable the lock cylinder 10 from the locked position without a matched key 60 in the keyhole 24. Besides, each of the pin sets 50 is biased toward the keyhole 24 in a first direction D1, and the position block 30 is biased toward the keyhole 24 in a second direction D2 which differs from the first direction D1 when the plug 20 is in the locked position. In this embodiment, the first direction D1 is perpendicular to the second direction D2. In this embodiment, the position block 30 is capable of moving within the axial groove 111 and has a first end face 30a facing the keyhole 24, a notch 31 which recesses from the first end face 30a and corresponds to the keyhole 24, a second end face 30b opposite to the first end face 30a, a third end face 30c facing the axial groove 111 and a protrusion 32 protruding from the third end face 30c. The protrusion 32 protruding from the plug 20 is movably disposed within the axial groove 111 of the hollow cylinder portion 11 capable of limiting the plug 20 not to be turned around. Referring again to FIGS. 1 and 3, in this embodiment, the resilient member 40 is disposed between the drive portion 23 of the plug 20 and the position block 30 and one end of the resilient member 40 contacts against the second end face 30b of the position block 30. The resilient member 40 is utilized for biasing the position block 30 toward the keyhole 24 in the second direction D2. It is preferable that the drive portion 23 of the plug 20 has a cavity 232 recessed from the bottom surface 231a to dispose another end of the resilient member 40. The pin sets 50 comprise a plurality of upper pins 51 and a plurality of lower pins 52, wherein the upper pins 51 and the lower pins 52 are disposed at the upper pin holes 12 and the lower pin holes 25, the pin sets 50 may utilize the upper pins 51 and the lower pins 52 to enable the plug 20 disposed relative to the cylinder body 10 to change state between the non-interference state and the interference state. In this embodiment, the non-interference state represents the upper pins 51 not being inserted into the lower pin holes 25 and the lower pins 52 not being inserted into the upper pin holes 12. In this case, the plug 20 inside the cylinder body 10 may not be interfered by the upper pins 51 or the lower pins 52. On the contrary, the interference state represents at least parts of the upper pins 51 being inserted into the lower pin holes 25 or at least parts of the lower pins 52 being inserted into the upper pin holes 12 therefore causing interference. In this case, engagement between the upper pins 51 and the lower pins 52 is capable of limiting the plug 20 not to be turned around, and the upper pins 51 is engageable with the lower pins 52 when the plug 20 is in the locked position.

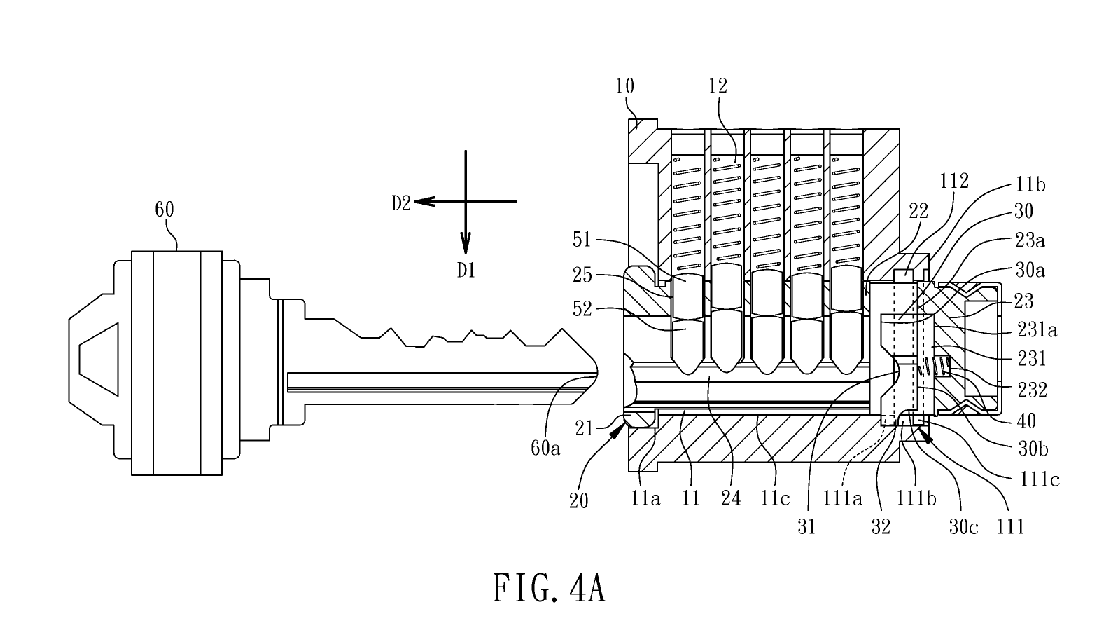

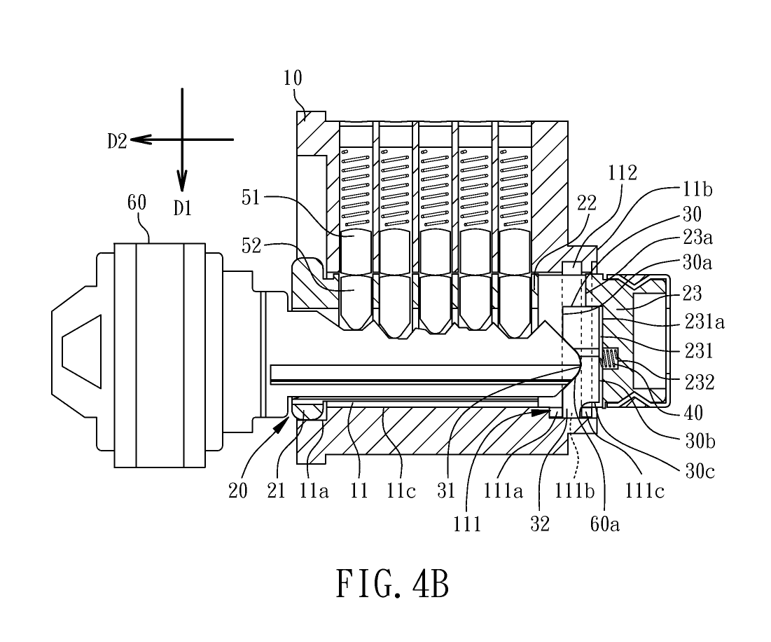

FIGS. 4A-4C illustrates motion of the lock cylinder assembly of this embodiment and first referring to FIG. 4A, which illustrates location of each component of the lock cylinder assembly before inserting a key. The protrusion 32 of the position block 30 is located at the first limiting area 111a of the axial groove 111 as to limit the plug 20 not to be turned around. Referring to FIG. 4B, when a matched key 60 is inserted into the keyhole 24 of the plug 20, the upper pins 51 are not inserted into the lower pin holes 25, the lower pins 52 are not inserted into the upper pin holes 12, therefore, the plug 20 is in the non-interference state. An end 60a of the matched key 60 joins with the notch 31 of the position block 30 and the matched key 60 pushes and moves the position block 30 to the accommodating cavity 231. In this embodiment, the matched key 60 pushes the position block 30 allowing the protrusion 32 of the position block 30 to move to the overlapping area 111b, which may relieve limiting condition of the protrusion 32 and the axial groove 111 to enable the position block 30 to be in the non-interference state. Next referring to FIG. 4C, when the matched key 60 turns the plug 20, the protrusion 32 of the position block 30 will move within the radial groove 112 of the hollow cylinder portion 11 to finish unlocking process. Besides, the resilient member 40 will pushes the position block 30 for restoration after the matched key 60 is pulled out from the plug 20 and the protrusion 32 restores to the first limiting area 111a of the axial groove 111 as to limit the plug 20 not to be turned around. The rotation limitation of the plug 20 represents that the position block 30 is in the interference state, furthermore, the upper pins 51 are located within the lower pin holes 25 and makes the plug 20 interfered by the upper pins 51, and the plug 20 may be limited from rotation.

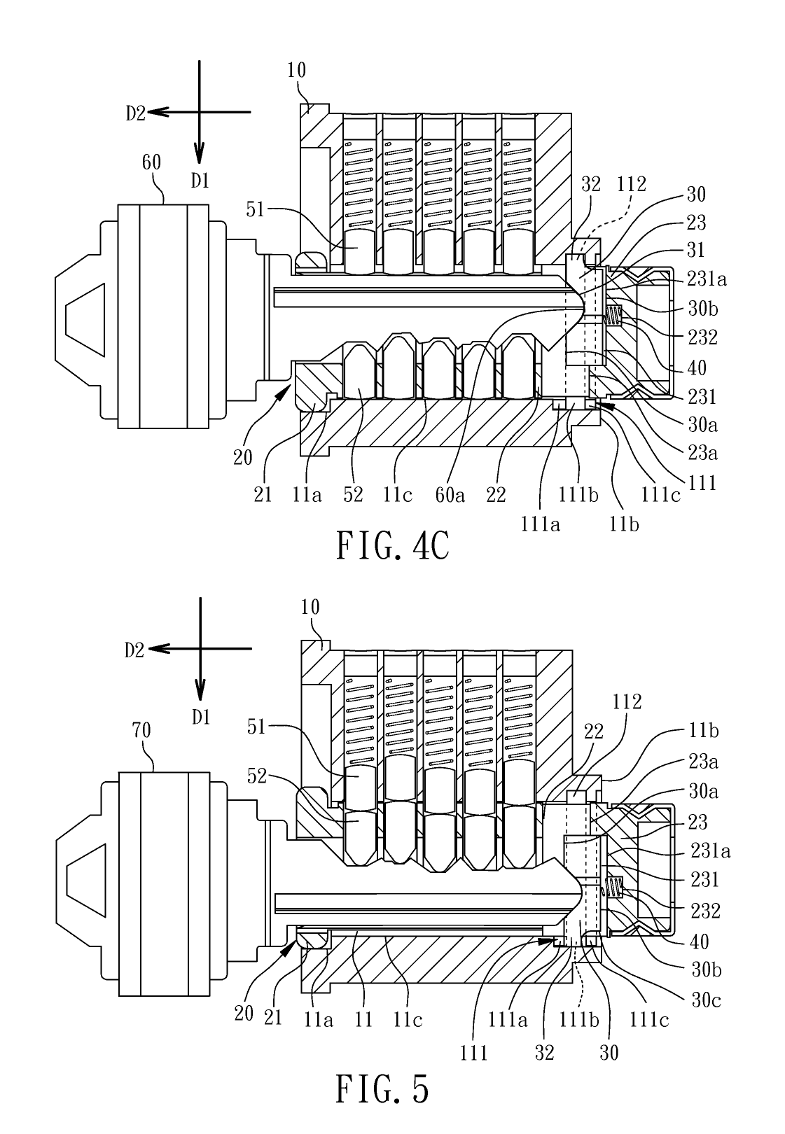

Referring to FIG. 5, if an unmatched key 70 is inserted into the keyhole 24 of the plug 20, although the unmatched key 70 may push the position block 30, it is unable to make the protrusion 32 of the position block 30 completely move to the overlapping area 111a, so the protrusion 32 is still limited at the first limiting area 111a of the axial groove 111 unable to relieve the condition of that the protrusion 32 limits the plug 20 not to be turned around. Mentioned limitation of the protrusion 32 indicates that the position block 30 is situated in the interference state. Therefore, a burglary attempting to turn the plug 20 violently for unlocking with the unmatched key 70 may be effectively prevented.

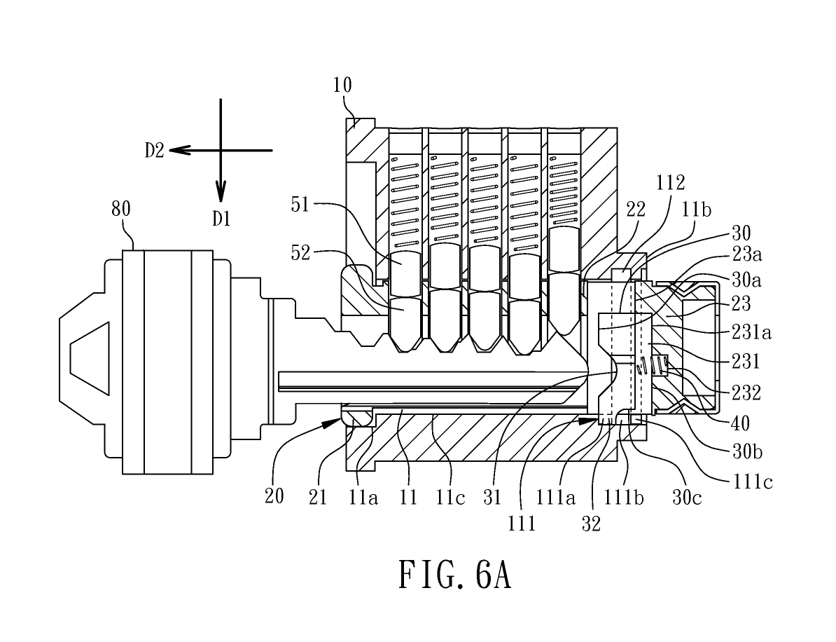

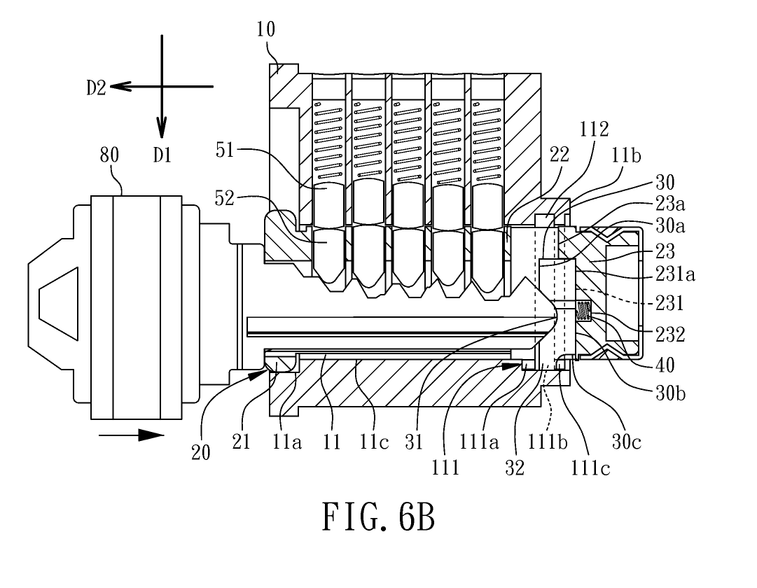

Referring to FIGS. 6A-6B, if an unmatched key 80 is inserted into the keyhole 24 of the plug 20 with opportune beat and turn for unlocking in a locked condition, first referring to FIG. 6A, when the unmatched key 80 doesn't hit the lower pins 52 and the position block 30, the protrusion 32 of the position block 30 is located at the first limiting area 111a of the axial groove 111 to limit the plug 20 not to be turned around. Next referring to FIG. 6B, the unmatched key 80 momentarily hits the lower pins 52 and the position block 30 to make the protrusion 32 of the position block 30 move from the first limiting area 111a of the axial groove 111 to the second limiting area 111c. In this case, inserting the unmatched key 80 into the keyhole 24 and actuating the pin sets 50 through impact may instantaneously make the upper pins 51 failed to insert the lower pin holes 25 and make the lower pins 52 failed to insert the upper pins 12. Therefore, the upper pins 51 or the lower pins 52 cannot limit the plug 20 not to turn around and the plug 20 is in the non-interference state. However, at this moment, the position block 30 contacts against the resilient member 40 to make the protrusion 32 of the position block 30 move within the second limiting area 111c of the axial groove 111. Consequently, the plug 20 is stuck by the position block 30 and limited from rotation, and the position block 30 is then in the interference state. In this embodiment, the resilient member 40 possesses a higher coefficient of elasticity to ensure that the position block 30 is not rebounded from the resilient member 40. Or even if the position block 30 is rebounded from the resilient member 40, the rebounding distance for the position block 30 is relatively short. At least part of the protrusion 32 is located within the second limiting area 111c of the axial groove 111 and still can limit the plug 20 effectively. The present invention also utilizes the position block 30 and the resilient member 40 to strengthen lock cylinder structure and increase unlocking difficulty for an unmatched key and thereby widely enhancing burglar-proof and security of the lock cylinder assembly.

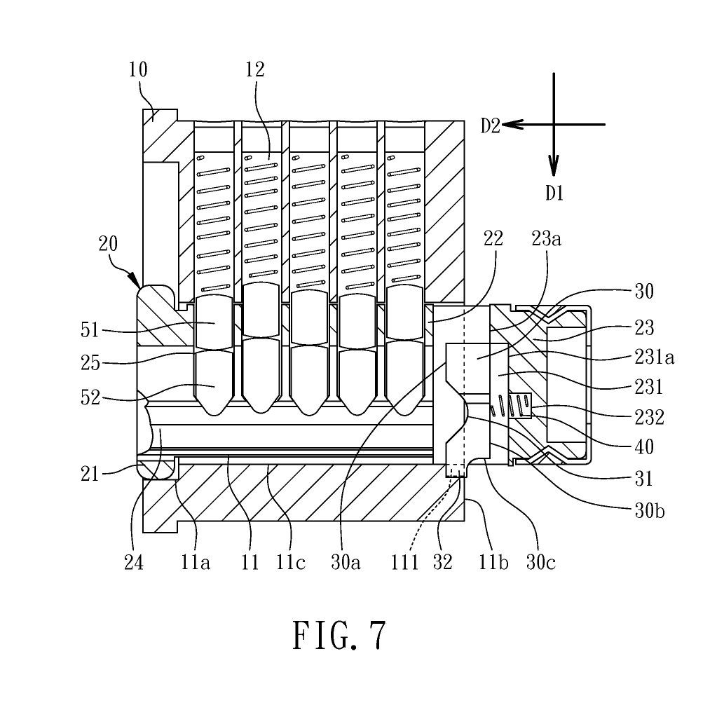

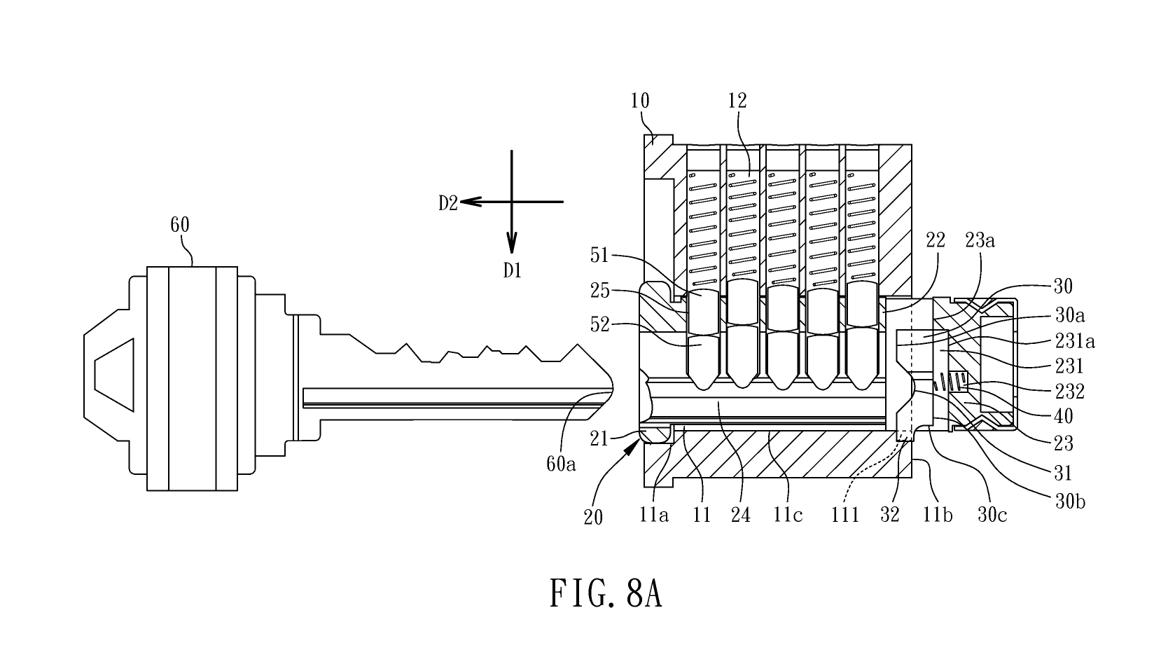

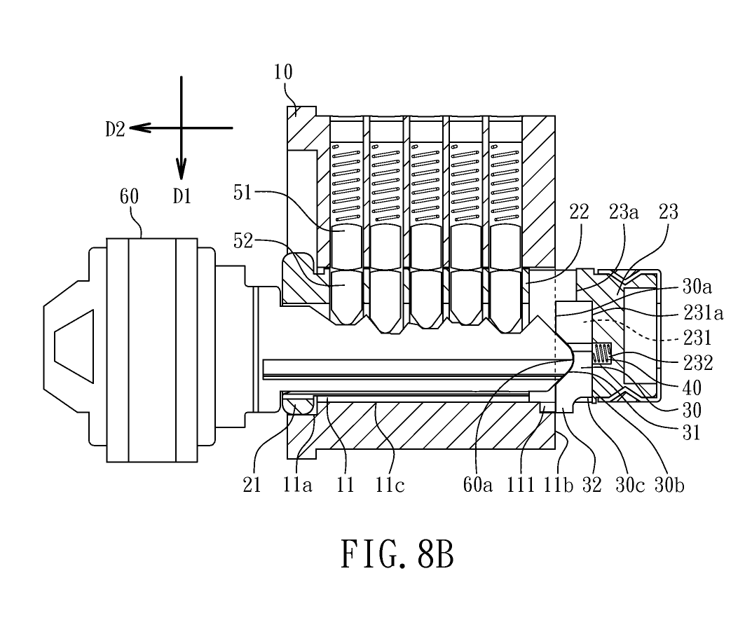

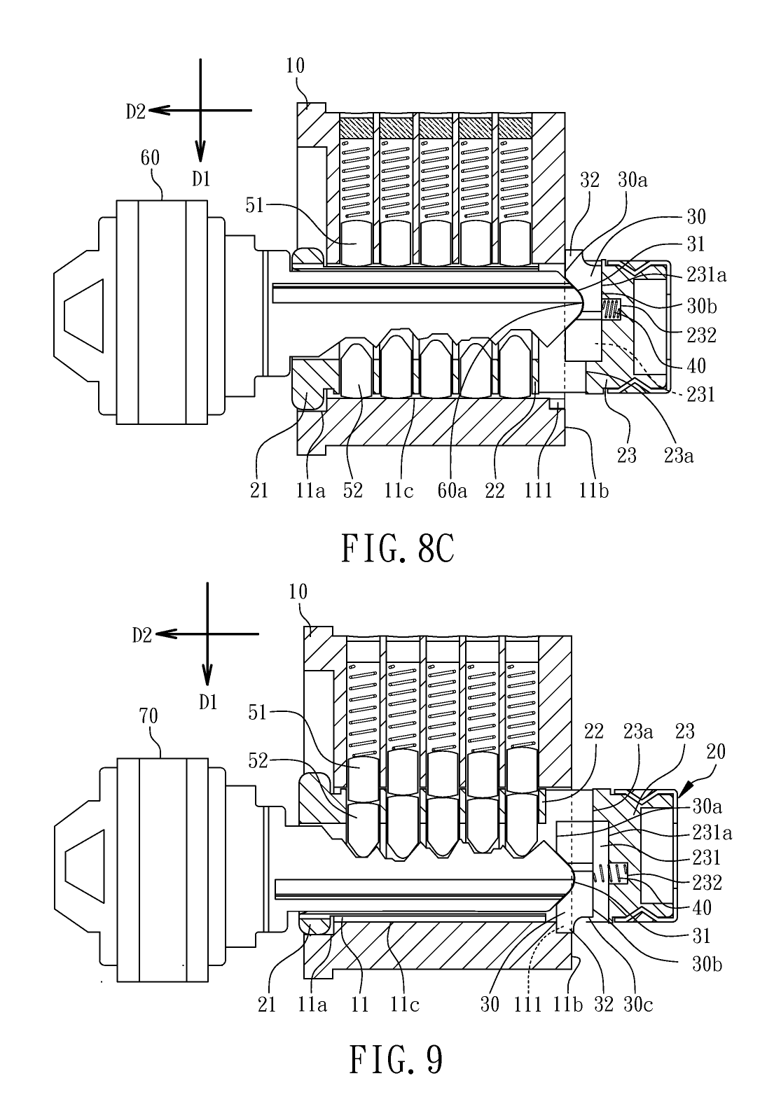

Referring to FIG. 7, which illustrates the second preferred embodiment of the present invention, the structural characteristic in this embodiment is basically the same as that in the first preferred embodiment, but the only difference is the radial groove 112 located at the hollow cylinder portion 11 of the cylinder body 10 which is omitted to fabricate in this embodiment. FIGS. 8A-8C illustrates motion of this embodiment and first referring to FIG. 8A, which illustrates location of each component of the lock cylinder assembly before inserting a key. The protrusion 32 of the position block 30 is located at the axial groove 111 of the hollow cylinder portion 11 to limit the plug 20 not to be turned around, which means the position block 30 is in the interference state. Referring to FIG. 8B, when the matched key 60 is inserted into the keyhole 24 of the plug 20, the end 60a of the matched key 60 joins with the notch 31 of the position block 30 and the matched key 60 pushes and moves the position block 30 to the accommodating cavity 231. In this embodiment, the matched key 60 pushes the protrusion 32 of the position block 30 away from the axial groove 111 capable of relieving the condition of that the protrusion 32 limits the plug 20 not to be turned around and the protrusion 32 will be located at the exterior of the hollow cylinder portion 11 at this moment, which means the position block 30 is in the non-interference state. Next referring to FIG. 8C, the matched key 60 turned the plug 20 for finishing unlocking process. The resilient member 40 pushes the position block 30 after pulling out the matched key 60 making the position block 30 restore and the protrusion 32 restores to the axial groove 111 remaining to limit the plug 20 not to be turned around.

Referring to FIG. 9, which illustrates an unmatched key 70 is inserted into the keyhole 24 of the plug 20 before attempting to turn the plug 20 violently, although the upper pins 51 and the lower pins 52 are lifted by the unmatched key 70, the plug 20 remains in the locked position cause the upper pins 51 and the lower pins 52 are in the interference state. Furthermore, the position block 30 is biased by the resilient member 40 such that the protrusion 32 is engaged within the axial groove 111, so that the condition of that the protrusion 32 limits the plug 20 not to be turned around cannot be dissolved, which represents that the position block 30 is also in the interference state.

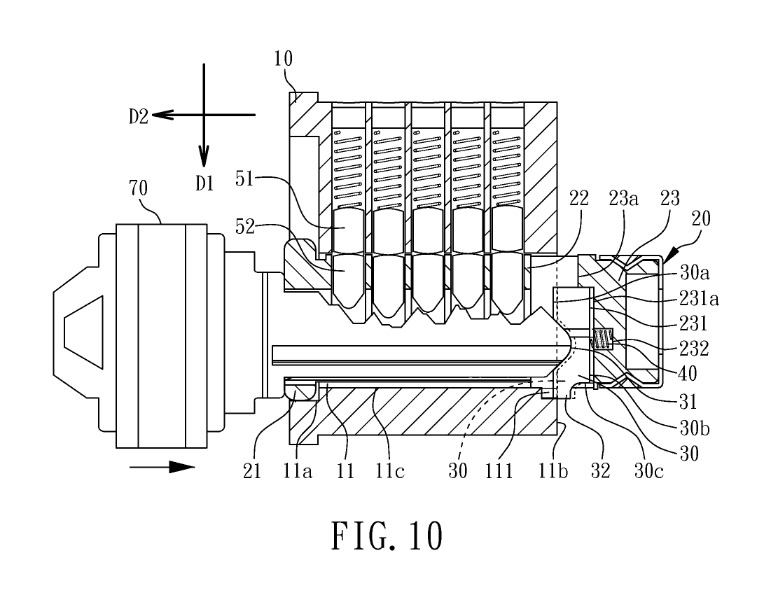

Referring to FIG. 10, when the unmatched key 70 is inserted into the keyhole 24 of the plug 20 with opportune beat for unlocking, the upper pins 51 and the lower pins 52 may rebound up and down therefore enabling the plug 20 to be in the non-interference state momentarily, and the plug 20 can not be limited from rotation at that moment. However, the position block 30 rebounds from the resilient member 40 and restores within the axial groove 111 immediately. Consequently, the plug 20 is stuck by the position block 30 and limited from rotation. The position block 30 is then in the interference state. In order to achieve immediate restoration, the resilient member 40 is selected with low coefficient of elasticity and high rebound speed. Owning the fact that the resilient member 40 possesses a low coefficient of elasticity and a high rebound speed, the position block 30 rebounded from the resilient member 40 may slide inside the axial groove 111 immediately. When the plug 20 is in the non-interference state, the position block 30 may be rebounded and moved to the axial groove 111 instantly. Consequently, the plug 20 is stuck by the position block 30 and limited from rotation, and the position block 30 is then situated in the interference state thereby widely enhancing burglar-proof and security of the lock cylinder assembly.

In this invention, the position block 30 may be located within the axial groove 111 via instantaneous impact of the unmatched key. Besides, the pin sets 50 are rebounded and enable the plug 20 to situate in the non-interference state, at that moment, a certain time difference is formed, during the time difference, burglar can not rotate the unmatched key 80 so that an illegally unlock can be effectively prevented. In the design of the first embodiment, during the time difference, the position block 30 may be stuck inside the second limiting area 111c of the axial groove 111. Otherwise, we may utilize the resilient member 40 with high rebound speed in the second embodiment instead of utilizing the second limiting area 111c in the first embodiment. The resilient member 40 with high rebound speed enables the position block 30 to rebound from the resilient member 40 and to be limited inside the axial groove 111. The scope of this invention is not restricted by the second limiting area 111c, the coefficient of the elasticity of the resilient member 40, or the rebound speed of the resilient member 40.

While the present invention has been particularly illustrated and described in detail with respect to the preferred embodiments thereof, it will be clearly understood by those skilled in the art that various changed in form and details may be made without departing from the spirit and scope of the present invention.

What is claimed is:

1. A lock cylinder assembly comprises at least:
a cylinder body;
a plug being rotatable within the cylinder body between a locked position and an unlocked position, and the plug comprises a keyhole;
a plurality of pin sets, the pin sets enable the plug disposed relative to the cylinder body to change state between a non-interference state and an interference state;
a position block, the position block enables the plug disposed relative to the cylinder body to change state between the non-interference state and the interference state; and
at least one of the pin sets and the position block is in the interference state to disable the lock cylinder from the locked position without a matched key in the keyhole.

2. The lock cylinder assembly in accordance with claim 1, wherein each of the pin sets is biased toward the keyhole in a first direction, and the position block is biased toward the keyhole in a second direction which differs from the first direction when the plug is in the locked position.

3. The lock cylinder assembly in accordance with claim 2, wherein the first direction is perpendicular to the second direction.

4. The lock cylinder assembly in accordance with claim 2 further comprises a resilient member for biasing the position block toward the keyhole in the second direction.

5. The lock cylinder assembly in accordance with claim 1, wherein the plug comprises a plurality of lower pin holes in communication with the keyhole, the cylinder body comprises a plurality of upper pin holes in communication with the lower pin holes, the pin sets comprise a plurality of upper pins disposed at the upper pin holes and a plurality of lower pins disposed at the lower pin holes, and the upper pins being engageable with the lower pins when the plug is in the locked position.

6. The lock cylinder assembly in accordance with claim 1, wherein the cylinder body comprises a hollow cylinder portion, the hollow cylinder portion has an inside wall and an axial groove recessed from the inside wall, the plug is disposed within the hollow cylinder portion and has a front portion, a middle portion and a drive portion, and the keyhole is formed at the front portion and the middle portion.

7. The lock cylinder assembly in accordance with claim 6, wherein the position block is disposed at the keyhole of the plug and protruded from the plug, the position block is corresponded to the axial groove of the hollow cylinder portion.

8. The lock cylinder assembly in accordance with claim 6 further comprises a resilient member disposed between the drive portion of the plug and the position block.

9. The lock cylinder assembly in accordance with claim 1, wherein the hollow cylinder portion comprises a has a first end corresponding to the front portion of the plug and a second end opposite to the first end, the axial groove is located at the second end.

10. The lock cylinder assembly in accordance with claim 6, wherein the position block is capable of moving within the axial groove of the hollow cylinder portion.

11. The lock cylinder assembly in accordance with claim 6, wherein the hollow cylinder portion further has a radial groove in communication with the axial groove, the axial groove comprises an overlapping area, and the overlapping area is an intersection area formed by the radial groove and the axial groove.

12. The lock cylinder assembly in accordance with claim 11, wherein the position block is capable of moving within the axial groove and the radial groove of the hollow cylinder portion.

13. The lock cylinder assembly in accordance with claim 8, wherein the position block has a first end face facing the keyhole, a second end face opposite to the first end face and a third end face facing the axial groove, one end of the resilient member contacts against the second end face of the position block.

14. The lock cylinder assembly in accordance with claim 13, wherein the position block has a notch recessed from the first end face, the notch corresponds to the keyhole of the plug.

15. The lock cylinder assembly in accordance with claim 13, wherein the drive portion of the plug has a cavity, another end of the resilient member is disposed at the cavity of the drive portion.

16. The lock cylinder assembly in accordance with claim 13, wherein the drive portion of the plug has an inner end face and an accommodating cavity recessed from the inner end face, the position block corresponds to the accommodating cavity.

17. The lock cylinder assembly in accordance with claim 11, wherein the axial groove comprises a first limiting area and a second limiting area, the first limiting area and the second limiting area are respectively located at two sides of the overlapping area.

18. The lock cylinder assembly in accordance with claim 13, wherein the position block further has a protrusion protruded from the third end face.
